(19) United States
(12) Patent Application Publication
(10) Pub. No.: US 2025/0023026 A1
(43) Pub. Date: Jan. 16, 2025

(54) ELECTROCHEMICAL DEVICE AND ELECTRONIC DEVICE

(71) Applicant: Ningde Amperex Technology Limited, Ningde (CN)

(72) Inventor: Xianglong HAN, Dongguan (CN)

(73) Assignee: Ningde Amperex Technology Limited, Ningde (CN)

(21) Appl. No.: 18/897,453

(22) Filed: Sep. 26, 2024

Related U.S. Application Data
(63) Continuation of application No. PCT/CN2022/083307, filed on Mar. 28, 2022.

(51) Int. Cl. H01M 4/36; H01M 4/02; H01M 4/505; H01M 4/58; H01M 10/0525

(52) U.S. Cl. CPC H01M 4/366; H01M 4/505; H01M 4/5825; H01M 10/0525; H01M 2004/021; H01M 2004/028

(57) ABSTRACT

A positive electrode of an electrochemical device includes a positive current collector and a positive active material layer located on one surface or both surfaces of the positive current collector. The positive active material layer includes a positive electrode material. The positive electrode material includes lithium manganese oxide and lithium iron phosphate. Based on a total mass of the positive electrode material, a mass percent of the lithium iron phosphate is denoted as a, satisfying: 5 wt %≤a≤20 wt %. Dᵥ₅₀ of the lithium iron phosphate is 0.8 μm to 2.0 μm. Dₙ₁₀ of the lithium iron phosphate is 0.2 μm to 0.5 μm. A specific surface area of the lithium iron phosphate is not less than 5 m²/g.

### CROSS-REFERENCE TO RELATED APPLICATIONS

This application is a continuation application of International Application No. PCT/CN2022/083307, filed on Mar. 28, 2022, the contents of which is incorporated herein by reference in its entirety.

### TECHNICAL FIELD

This application relates to the field of electrochemical technology, and in particular, to an electrochemical device and an electronic device.

### BACKGROUND

With the advantages such as a high energy density, a high power, and a long cycle life, electrochemical devices such as a lithium-ion battery are widely used in various fields. In order to reduce the cost of the electrochemical devices, lithium manganese oxide is usually used as a positive electrode material in a positive electrode of an electrochemical device. However, the lithium manganese oxide may react with hydrofluoric acid in an electrolyte solution to dissolve out manganese. The manganese dissolved out is deposited on a negative electrode, thereby eventually disrupting a solid electrolyte interphase (SEI) film of the positive electrode, resulting in lithium plating in a charging or discharging process, and posing safety hazards.

### SUMMARY

Some embodiments of this application disclose an electrochemical device. The electrochemical device includes a positive electrode. The positive electrode includes a positive current collector and a positive active material layer located on one surface or both surfaces of the positive current collector. The positive active material layer includes a positive electrode material. The positive electrode material includes lithium manganese oxide and lithium iron phosphate. Based on a total mass of the positive electrode material, a mass percent of the lithium iron phosphate is denoted as a, satisfying: 5 wt %≤a≥20 wt %. Dᵥ₅₀ of the lithium iron phosphate is 0.8 μm to 2.0 μm. Dₙ₁₀ of the lithium iron phosphate is 0.2 μm to 0.5 μm. A specific surface area of the lithium iron phosphate is not less than 5 m²/g. By controlling the mass percent, particle size, and specific surface area of the lithium iron phosphate to fall within an appropriate range, this application solves the problems of floating of the lithium iron phosphate as well as dryness and cracking of an electrode plate while suppressing manganese dissolution through the lithium iron phosphate to improve the safety of the electrochemical device.

In some embodiments of this application, a mass percent of the lithium iron phosphate satisfies: 10 wt %≤a≤20 wt %. In some embodiments, Dᵥ₅₀ of the lithium iron phosphate is 1.1 μm to 1.8 μm. In some embodiments, Dₙ₁₀ of the lithium iron phosphate is 0.2 μm to 0.4 μm. In some embodiments, a specific surface area of the lithium iron phosphate greater than 8 m²/g.

In some embodiments of this application, a specific surface area of the lithium manganese oxide is 0.2 m²/g to 0.7 m²/g. In some embodiments, the lithium iron phosphate is attached to the surface of the lithium manganese oxide. The specific surface area of lithium manganese oxide affects the floating force and sinking force of lithium iron phosphate. When the specific surface area of lithium manganese oxide is overly small, lithium manganese oxide and lithium iron phosphate are prone to sink in the slurry. When the specific surface area of lithium manganese oxide is overly large, lithium manganese oxide and lithium iron phosphate are prone to float in the slurry. When the specific surface area of lithium manganese oxide falls within the above range, the floating force and the sinking force are balanced, thereby avoiding uneven distribution caused by slurry deposition and avoiding the problem of slurry floating.

In some embodiments of this application, the positive electrode material further includes lithium nickel cobalt manganese oxide. Based on the total mass of the positive electrode material, a mass percent of the nickel cobalt manganese oxide is denoted as b, satisfying: 0 wt %<b≤10 wt %. In some embodiments, the lithium nickel cobalt manganese oxide can form a coating on the lithium manganese oxide, thereby reducing the reactivity between the electrolyte solution and the lithium manganese oxide. At the same time, controlling the lithium nickel cobalt manganese oxide to fall within the above mass range can reduce cost while ensuring a good effect.

In some embodiments of this application, at least a part of the positive electrode material is a core-shell structure. The lithium manganese oxide is located in a core of the core-shell structure. The lithium iron phosphate and the lithium nickel cobalt manganese oxide are located in a shell layer of the core-shell structure, thereby preventing manganese dissolution. In some embodiments of this application, at least a part of the positive electrode material is a core-shell structure. The lithium manganese oxide is located in a core of the core-shell structure. The lithium iron phosphate is located in a shell layer of the core-shell structure. In some embodiments, the lithium iron phosphate forms a coating on lithium manganese oxide, thereby reducing the reactive sites between the electrolyte solution and the lithium manganese oxide, and in turn, preventing manganese dissolution.

In some embodiments of this application, the positive electrode material contains at least one of B, Mg, Al, Si, S, Ti, Cr, Cu, Zn, Ga, Ge, Y, Zr, Mo, Ag, Ba, W, In, Sn, Pb, or Sb, thereby improving the conductivity.

In some embodiments of this application, the positive active material layer includes a first layer and a second layer. The first layer is located between the positive current collector and the second layer. A difference between a mass percent of iron element in the first layer and a mass percent of iron element in the second layer is not greater than 0.5%. This indicates that the lithium iron phosphate in this application is evenly distributed in the positive active material layer, without incurring the problems of sinking or floating. In some embodiments of this application, a difference between a thickness of the first layer and a thickness of the second layer is not greater than 20%. In some embodiments of this application, the first layer includes lithium manganese oxide and lithium iron phosphate, and the second layer includes lithium manganese oxide and lithium iron phosphate; or the first layer includes lithium manganese oxide, lithium iron phosphate, or lithium nickel cobalt manganese oxide, and the second layer includes lithium manganese oxide, lithium iron phosphate, and lithium nickel cobalt manganese oxide.

In some embodiments of this application, based on the total mass of the positive electrode material, a mass percent of the lithium manganese oxide in the second layer is d; and, based on the total mass of the positive electrode material, a mass percent of the lithium manganese oxide in the first layer is e, satisfying: d<e.

In some embodiments of this application, the positive active material layer further includes a binder and a conductive agent. In some embodiments of this application, an electronic device is disclosed. The electronic device includes the electrochemical device disclosed in any one of the above embodiments.

This application further discloses an electronic device. The electronic device includes the electrochemical device disclosed in any one of the above embodiments of this application. The positive electrode in this application includes a positive current collector and a positive active material layer located on one surface or both surfaces of the positive current collector. The positive active material layer includes a positive electrode material. The positive electrode material includes lithium manganese oxide and lithium iron phosphate. Based on a total mass of the positive electrode material, a mass percent of the lithium iron phosphate is denoted as a, satisfying: 5 wt %≤a≤20 wt %. Dᵥ₅₀ of the lithium iron phosphate is 0.8 μm to 2.0 μm. Dₙ₁₀ of the lithium iron phosphate is 0.2 μm to 0.5 μm. A specific surface area of the lithium iron phosphate is not less than 5 m²/g. By controlling the mass percent, particle size, and specific surface area of the lithium iron phosphate to fall within an appropriate range, this application solves the problems of floating of the lithium iron phosphate as well as dryness and cracking of an electrode plate while improving the safety of the electrochemical device.

### DETAILED DESCRIPTION

The following embodiments enable a person skilled in the art to understand this application more comprehensively, but without limiting this application in any way.

In this application, being “equal” or “identical” between two objects means that the discrepancy between the two objects is less than 30%, 20%, 10%, or 5%. The discrepancy is a result obtained by dividing a difference by a lesser one of the two objects and then multiplying the quotient by 100%, where the difference is obtained by subtracting the lesser one from the greater one of the two objects.

Electrochemical devices, such as a lithium-ion battery, are widely used in various fields. In order to reduce the cost of electrochemical devices, lithium manganese oxide is used as a positive electrode material in a positive electrode of the battery. The spinel structure of lithium manganese oxide is characterized by a resistance to low temperature, high C-rate performance, ease of preparation, and the like. However, the lithium manganese oxide material is unstable. Lithium manganese oxide easily reacts with hydrofluoric acid in the electrolyte solution to cause manganese dissolution, thereby disrupting the SEI film of a negative electrode, resulting in lithium plating, and posing safety hazards. Lithium manganese oxide is inferior in high-temperature performance and cycle performance. Such characteristics are all attributable to the properties of manganese.

Some embodiments of this application disclose an electrochemical device. The electrochemical device may be a lithium-ion battery. The electrochemical device includes a positive electrode, and may further include a negative electrode and a separator. The positive electrode includes a positive current collector and a positive active material layer located on one surface or both surfaces of the positive current collector. The positive current collector may be a copper foil or aluminum foil. The positive active material layer includes a positive electrode material. The positive electrode material includes lithium manganese oxide and lithium iron phosphate. Based on a total mass of the positive electrode material, a mass percent of the lithium iron phosphate is denoted as a, satisfying: 5 wt %≤a≤20 wt %. Dᵥ₅₀ of the lithium iron phosphate is 0.8 μm to 2.0 μm. Dₙ₁₀ of the lithium iron phosphate is 0.2 μm to 0.5 μm. Dₙ₁₀ is a particle diameter corresponding to the cumulative quantity distribution percentage reaching 10%, that is, the particle diameters of 10% of the specimen particles are less than or equal to this particle diameter. A specific surface area of the lithium iron phosphate is not less than 5 m²/g.

In this application, lithium iron phosphate and lithium manganese oxide are used in the positive electrode material at the same time. Lithium iron phosphate can effectively absorb hydrofluoric acid and form a coating on the lithium manganese oxide, thereby reducing the reactive sites between the electrolyte solution and the lithium manganese oxide, and effectively suppressing manganese dissolution. However, the lithium iron phosphate is of a nanoscale particle diameter, and therefore, is prone to float in a process of preparing a slurry and cause the positive active material layer to crack during drying of the positive electrode. In order to solve the problems of floating and cracking of the lithium iron phosphate, this application controls the mass percent, Dᵥ₅₀, Dₙ₁₀, and specific surface area of the lithium iron phosphate to fall within an appropriate range. When the above characteristics of lithium iron phosphate meet the range specified herein, the lithium iron phosphate can be suppressed from floating and prevented from cracking. When the specified range is not fully met, the lithium iron phosphate is prone to float or the positive active material layer is prone to crack, thereby resulting in inferior performance of the electrochemical device. The electrochemical device disclosed in an embodiment of this application employs the above positive electrode material, thereby effectively solving the problems of cracking of the electrode plate and floating of lithium iron phosphate while reducing the cost of the positive electrode material and preventing manganese dissolution.

In an embodiment of this application, the mass percent of lithium iron phosphate in the positive electrode material is not less than 5 wt %, so as to ensure sufficiency of lithium iron phosphate to suppress manganese dissolution. When the mass percent of lithium iron phosphate in the positive electrode material does not exceed 20 wt %, the electrochemical device exhibits superior low-temperature performance. When the mass percent of lithium iron phosphate exceeds 20%, the low-temperature performance of the electrochemical device deteriorates significantly. In some embodiments of this application, the electrochemical device is charged at a current of 2A at a normal temperature of 20° C. to 25° C. from 0% SOC (State of Charge) until the voltage reaches 3.65 V, so as to obtain a charge capacity C₁. After standing in a −20° C. environment for 2 hours, the electrochemical device is discharged at a 0.5C rate until the voltage drops to 2.5 V, so as to obtain a discharge capacity C₂. The ratio of the discharge capacity C₂ to the charge capacity C₁ of the electrochemical device is greater than 75%, thereby indicating that the electrochemical device in this application exhibits good low-temperature performance.

In some embodiments of this application, the mass percent of lithium iron phosphate satisfies: 10 wt %≤a≤20 wt %. In some embodiments, if the mass percent of lithium iron phosphate is overly low, hydrofluoric acid may be not well absorbed. Controlling the mass percent of lithium iron phosphate to be not less than 10% can ensure proper protection for the lithium manganese oxide.

The mass percent of a compound (for example, lithium iron phosphate, lithium manganese oxide, or lithium nickel cobalt manganese oxide) in the active material layer may be measured by using X-ray photoelectron spectroscopy (XPS), or may be measured by X-ray diffractometry. The content of the characteristic elements is measured to deduce the content of active materials. The specific test principles and test details are based on existing technologies in this field, the details of which are omitted herein.

In some embodiments, Dᵥ₅₀ of lithium iron phosphate is 1.1 μm to 1.8 μm. In some embodiments, Dₙ₁₀ of lithium iron phosphate is 0.2 μm to 0.4 μm. In some embodiments, Dᵥ₅₀ and Dₙ₁₀ of lithium iron phosphate characterize the particle diameter of lithium iron phosphate. If the particle diameter of lithium iron phosphate is overly small, the electrolyte solution is consumed quickly. If the particle diameter of lithium iron phosphate is overly large, the lithium iron phosphate is not conductive to the C-rate performance, and is unable to protect the lithium manganese oxide properly. In some embodiments, the specific surface area of lithium iron phosphate is greater than 8 m²/g. In some embodiments, the specific surface area of lithium iron phosphate affects the contact area between the lithium iron phosphate and the electrolyte solution on the one hand, and affects the contact area between the lithium iron phosphate and the lithium manganese oxide on the other hand. Therefore, the specific surface area of lithium iron phosphate needs to avoid being overly small. A small specific surface area of lithium iron phosphate makes the lithium iron phosphate unable to cover the lithium manganese oxide properly and unable to absorb hydrofluoric acid properly. In some embodiments, the specific surface area of the lithium iron phosphate is greater than 8 m²/g and less than 17 m²/g. In some embodiments, the specific surface area of the lithium iron phosphate is greater than 8 m²/g and less than 15 m²/g.

In some embodiments of this application, a specific surface area of the lithium manganese oxide is 0.2 m²/g to 0.7 m²/g. In some embodiments, the lithium iron phosphate is attached to the surface of the lithium manganese oxide. The specific surface area of lithium manganese oxide affects the floating force and sinking force of lithium iron phosphate. When the specific surface area of lithium manganese oxide is overly small, lithium manganese oxide and lithium iron phosphate are prone to sink in the slurry. When the specific surface area of lithium manganese oxide is overly large, lithium manganese oxide and lithium iron phosphate are prone to float in the slurry. When the specific surface area of lithium manganese oxide falls within the above range, the floating force and the sinking force are substantially balanced, thereby avoiding uneven distribution caused by slurry deposition and avoiding the problem of slurry floating.

In some embodiments of this application, the specific surface area of the particles may be measured by using a specific surface area tester. The details of the measurement are omitted herein.

In some embodiments of this application, the positive electrode material further includes lithium nickel cobalt manganese oxide. Based on the total mass of the positive electrode material, a mass percent of the nickel cobalt manganese oxide is denoted as b, satisfying: 0 wt %<b≤10 wt %. In some embodiments, the lithium nickel cobalt manganese oxide can form a coating on the lithium manganese oxide, thereby reducing the reactivity between the electrolyte solution and the lithium manganese oxide. At the same time, controlling the lithium nickel cobalt manganese oxide to fall within the above mass range can reduce cost while ensuring a good effect. In some embodiments of this application, 1 wt %<b≤10 wt %.

In some embodiments of this application, the positive electrode material contains at least one of B, Mg, Al, Si, S, Ti, Cr, Cu, Zn, Ga, Ge, Y, Zr, Mo, Ag, Ba, W, In, Sn, Pb, or Sb. In some embodiments, the impurity atoms in the positive electrode material form carriers, thereby improving the conductivity of the positive electrode material, thereby improving the C-rate performance and cycle performance of the electrochemical device.

In some embodiments, the positive active material layer includes a first layer and a second layer. The first layer is located between the positive current collector and the second layer. The thickness of the first layer may be the same as or different from the thickness of the second layer. The type of the active material included in the first layer may be the same as or different from the type of the active material included in the second layer.

In some embodiments, the type of the active material included in the first layer is the same as the type of the active material included in the second layer. For example, the first layer includes lithium manganese oxide and lithium iron phosphate, and the second layer includes lithium manganese oxide and lithium iron phosphate. Alternatively, the first layer includes lithium manganese oxide, lithium iron phosphate, or lithium nickel cobalt manganese oxide, and the second layer includes lithium manganese oxide, lithium iron phosphate, and lithium nickel cobalt manganese oxide.

In some embodiments of this application, the first layer is located between the positive current collector and the second layer. A difference between a mass percent of iron element in the first layer and a mass percent of iron element in the second layer is not greater than 0.5%. In some embodiments, the thickness of the first layer may be the same as the thickness of the second layer. For a target region on the positive current collector, the difference between the mass percent of iron in the first layer and the mass percent of iron in the second layer in the target region is not greater than 0.5%. In some embodiments, the positive active material layer on either surface of the positive current collector is divided into a first layer and a second layer along the thickness direction. For any target region, the mass percent of iron in the first layer in the target region is almost identical to the mass percent of iron in the second layer in the target region, indicating that the lithium iron phosphate is evenly distributed in the positive active material layer, without incurring the problem of floating of the lithium iron phosphate. In some embodiments, a difference between a thickness of the first layer and a thickness of the second layer is not greater than 20%.

In some embodiments, the type of the active material included in the first layer is different from the type of the active material included in the second layer. Based on the total mass of the positive electrode material, the mass percent of the lithium manganese oxide in the second layer is d. Based on the total mass of the positive electrode material, the mass percent of the lithium manganese oxide in the first layer is e, satisfying: d<e. In this way, compared with the second layer far away from the current collector side, the first layer close to the current collector side contains more lithium manganese oxide. The concentration of hydrofluoric acid in the first layer is lower, thereby reducing manganese dissolution in the positive active material layer.

In some embodiments of this application, at least a part of the positive electrode material is a core-shell structure. The lithium manganese oxide is located in a core of the core-shell structure. The lithium iron phosphate is located in a shell layer of the core-shell structure. In some embodiments, the lithium iron phosphate forms a coating on lithium manganese oxide, thereby reducing the reactive sites between the electrolyte solution and the lithium manganese oxide, and in turn, preventing manganese dissolution and alleviating the degree of the electrolyte solution eroding the lithium manganese oxide. In some embodiments of this application, at least a part of the positive electrode material is a core-shell structure. The lithium manganese oxide is located in a core of the core-shell structure. The lithium iron phosphate and the lithium nickel cobalt manganese oxide are located in a shell layer of the core-shell structure, thereby further preventing manganese dissolution.

In some embodiments of this application, the positive active material layer further includes a binder and a conductive agent. The binder may be polyvinylidene difluoride, and the conductive agent may be one or more of conductive carbon black, carbon nanotubes, or graphite.

In some embodiments, the electrochemical device includes a separator disposed between the positive electrode and the negative electrode. In some embodiments, the separator includes at least one of polyethylene, polypropylene, polyvinylidene fluoride, polyethylene terephthalate, polyimide, or aramid fiber. For example, the polyethylene includes at least one of high-density polyethylene, low-density polyethylene, or ultra-high-molecular-weight polyethylene. Especially, the polyethylene and the polypropylene are highly effective in preventing short circuits, and can improve stability of the battery through a turn-off effect. In some embodiments, the thickness of the separator is within a range of approximately 5 μm to 50 μm.

In some embodiments, a surface of the separator may further include a porous layer. The porous layer is disposed on at least one surface of the separator. The porous layer includes inorganic particles and a binder. The inorganic particles are at least one selected from aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, and barium sulfate. In some embodiments, a diameter of a pore of the separator is within a range of approximately 0.01 μm to 1 μm. The binder in the porous layer is at least one selected from polyvinylidene difluoride, poly(vinylidene difluoride-co-hexafluoropropylene), polyamide, polyacrylonitrile, polyacrylic ester, polyacrylic acid, sodium polyacrylate, sodium carboxymethyl cellulose, polyvinylpyrrolidone, polyvinyl ether, polymethyl methacrylate, polytetrafluoroethylene, and polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrochemical device may be a jelly-roll structure or a stacked structure. In some embodiments, the positive electrode and/or negative electrode of the electrochemical device may be a multi-layer structure formed by winding or stacking, or may be a single-layer structure formed by stacking a single layer of positive electrode, a separator, and a single layer of negative electrode.

In some embodiments of this application, the electrochemical device includes, but is not limited to, a lithium-ion battery. In some embodiments, the electrochemical device may further include an electrolyte. The electrolyte may be one or more of a gel electrolyte, a solid-state electrolyte, or an electrolyte solution. The electrolyte solution includes a lithium salt and a nonaqueous solvent. The lithium salt is one or more selected from LiPF₆, LiBF₄, LiAsF₆, LiCIO₄, LiB(C₆H₅)₄, LICH₃SO₃, LiCF₃SO₃, LIN(SO₂CF₃)₂, LiC(SO₂CF₃)₃, LiSiF₆, LiBOB, and lithium difluoroborate. For example, the lithium salt is LiPF₆ because this lithium salt is of a high ionic conductivity and can improve cycle characteristics.

The nonaqueous solvent may be a carbonate ester compound, a carboxylate ester compound, an ether compound, another organic solvent, or any combination thereof. The carbonate ester compound may be a chain carbonate ester compound, a cyclic carbonate ester compound, a fluorocarbonate ester compound, or any combination thereof.

Examples of the chain carbonate ester compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate ester compound are ethylene carbonate (EC), propylene carbonate (PC), butylene carbonate (BC), vinyl ethylene carbonate (VEC), or any combination thereof. Examples of the fluorocarbonate ester compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or any combination thereof.

In some embodiments of this application, using a lithium-ion battery as an example, the lithium-ion battery is prepared by: winding or stacking the positive electrode, the separator, and the negative electrode sequentially into an electrode assembly, putting the electrode assembly into a package such as an aluminum laminated film ready for sealing, injecting an electrolyte solution, and performing chemical formation and sealing; Subsequently, a performance test is performed on the prepared lithium-ion battery.

A person skilled in the art understands that the method for preparing the electrochemical device (such as a lithium-ion battery) described above is merely an example. To the extent not departing from the content disclosed herein, other methods commonly used in the art may be employed.

This application discloses an electronic device containing an electrochemical device. The electrochemical device is any one of the electrochemical devices disclosed herein. The electronic device according to this embodiment of this application is not particularly limited, and may be any electronic device known in the prior art. In some embodiments, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, unmanned aerial vehicle, lighting appliance, toy, game console, watch, electric tool, flashlight, camera, large household storage battery, or the like.

Some specific embodiments and comparative embodiments are enumerated below to give a clearer description of this application, using a lithium-ion battery as an example.

Preparing a positive electrode: Dissolving a positive electrode material, conductive carbon black, carbon nanotubes, and polyvinylidene difluoride at a mass ratio of 96.2:0.8:0.6:2.4 in an N-methyl-pyrrolidone solvent to form a positive electrode slurry. Using an aluminum foil as a positive current collector (16 μm thick), coating the positive current collector with the positive electrode slurry (the coating weight is 0.23 kg/m²), and performing steps such as drying, cold pressing (the thickness of the electrode plate is 0.17 mm), and cutting to obtain a positive electrode.

Preparing a negative electrode: Mixing the negative electrode materials graphite, styrene acrylate, and lithium carboxymethyl cellulose at a mass ratio of 98:1:1, and adding deionized water as a solvent to form a slurry of the negative active material layer. Using a copper foil as a negative current collector, applying the slurry of the negative active material layer onto the negative current collector, and oven-drying the slurry at 90° C. to obtain a negative electrode plate.

Preparing a separator: Using an 8 μm-thick polyethylene (PE) film as a separator.

Preparing an electrolyte solution: Mixing lithium hexafluorophosphate with a nonaqueous organic solvent at a mass ratio of 8:92 in an environment with a moisture content of less than 10 ppm to prepare an electrolyte solution, where the nonaqueous organic solvent is a mixture of ethylene carbonate (EC): diethyl carbonate (DEC): propylene carbonate (PC): propyl propionate (PP): vinylene carbonate (VC) mixed at a mass ratio of 20:30:20:28:2.

Preparing a lithium-ion battery: Stacking the positive electrode, the separator, and the negative electrode sequentially in such a way that the separator is located between the positive electrode plate and the negative electrode plate to serve a function of separation, and winding the stacked structure to obtain an electrode assembly. Putting the electrode assembly into an outer package made of an aluminum laminated film, dehydrating the electrode assembly at 80° C., injecting the electrolyte solution, and sealing the package. Performing steps such as chemical formation, degassing, and edge trimming to obtain a lithium-ion battery.

The following describes the test method of this application.

### 1. Measuring the Dₙ₁₀

Scanning the cross-section of the electrode plate along the thickness direction by use of a scanning electron microscope to obtain a scanning electron microscope (SEM) image. Specifically, performing sampling: Disassembling an electrochemical device specimen, taking out an electrode plate, and soaking the electrode plate in a dimethyl carbonate (DMC) solution for 6 hours to remove the residual electrolyte solution. Finally, drying the electrode plate in an oven. Preparing a specimen: Cutting out a to-be-tested section of the electrode plate with a knife, that is, a section of the active material layer sectioned along the thickness direction; pasting the specimen onto paraffin by using a heating plate, and polishing the to-be-tested section with an ion polisher, so that an SEM specimen is obtained after the surface of the section is smooth. Testing the specimen: Using a scanning electron microscope (SEM) to obtain an SEM image of the active material layer of the electrochemical device specimen. Determining the average diameter of the active material in the obtained SEM image. Specifically, for an individual particle, determining the length of the longest diagonal of the particle in the SEM photo containing the particle, and determining the length of the shortest diagonal of the particle. The particle diameter of the particle is an arithmetic average of the length of the longest diagonal and the length of the shortest diagonal. Selecting n (for example, 100) active material particles randomly in the SEM image, and determining the particle diameter of each active material particle to obtain n particle diameters. Sorting the particle diameters of the obtained n particles in ascending order, and defining that the particle diameter of the particle reaching 10% of the total number of particle specimens is Dₙ₁₀.

### 2. Measuring the Dᵥ₅₀

Plotting a cumulative particle size distribution curve of the negative active material by using MasterSizer 2000. Dᵥ₅₀ represents a particle diameter of specimen particles at which the cumulative volume of the particles reaches 50% of the total volume of all specimen particles in a volume-based particle size distribution curve observed from a small-diameter side, and is determined by using a laser scattering particle size analyzer.

3. Detecting the cracks of the electrode plate: Observing the positive electrode in the electrochemical device. Determining that no cracking occurs if the crack in the positive active material layer of the positive electrode is not larger than 0.5 mm; otherwise, determining that cracking occurs.
4. Detecting uniformity of distribution of lithium iron phosphate (uniform distribution of Fe ions):

Dividing the positive active material layer on one surface of the positive current collector into an upper layer (second layer) and a lower layer (first layer) evenly in the thickness direction. Scanning the two layers by using an energy dispersive spectrometer, and selecting one region on the positive current collector randomly to obtain the difference in mass percent of Fe between the two layers.

### 5. Testing the −20° C. Low-Temperature Discharge Performance

Charging an electrochemical device at a current of 2A at a normal temperature of 20° C. to 25° C. from 0% SOC (State of Charge) until the voltage reaches 3.65 V, so as to obtain a charge capacity C₁. Leaving the electrochemical device to stand in a −20° C. environment for 2 hours, and discharging the electrochemical device at a 0.5C rate until the voltage drops to 2.5 V, so as to obtain a discharge capacity C₂. Calculating the ratio of the discharge capacity C₂ to the charge capacity C₁ of the electrochemical device.

The embodiments and comparative embodiments differ in the composition and the properties of the positive electrode material. The specific differences and performance test results are shown in the table below.

TABLE 1
(To Be Continued)

| | | | | | Mass |
|---|---|---|---|---|---|
| | | | | | percent |
| | | | | | b of |
| | Dᵥ₅₀ of | Dₙ₁₀ of | BET of | Mass | lithium |
| | lithium | lithium | lithium | percent | nickel |
| | iron | iron | iron | a of | cobalt |
| | phos- | phos- | phos- | lithium | man- |
| | phate | phate | phate | iron | ganese |
| Embodiment | (μm) | (μm) | (m²/g) | phosphate | oxide |
| Embodiment 1 | 1.1 | 0.35 | 10 | 5 | 5% |
| Comparative | 1.1 | 0.35 | 10 | 3.8% | 5% |
| Embodiment 1 | | | | | |
| Comparative | 1.1 | 0.35 | 10 | 23% | 5% |
| Embodiment 2 | | | | | |
| Comparative | 1.0 | 0.7 | 7 | 40% | 7% |
| Embodiment 3 | | | | | |
| Embodiment 2 | 0.8 | 0.5 | 11 | 15% | 10% |
| Embodiment 3 | 2.0 | 0.5 | 5 | 15% | 10% |
| Comparative | 0.6 | 0.5 | 11 | 15% | 10% |
| Embodiment 4 | | | | | |
| Comparative | 2.3 | 0.5 | 11 | 15% | 10% |
| Embodiment 5 | | | | | |
| Comparative | 0.6 | 0.4 | 9 | 20% | 10% |
| Embodiment 6 | | | | | |
| Comparative | 0.6 | 0.2 | 15 | 20% | 2% |
| Embodiment 7 | | | | | |
| Embodiment 4 | 2.0 | 0.2 | 6 | 20% | 0% |
| Embodiment 5 | 2.0 | 0.5 | 5 | 20% | 0% |
| Comparative | 1.0 | 0.1 | 15 | 20% | 10% |
| Embodiment 8 | | | | | |
| Embodiment 6 | 1.1 | 0.35 | 12 | 15% | 8% |
| Comparative | 1.1 | 0.35 | 3.5 | 15% | 8% |
| Embodiment 9 | | | | | |
| Comparative | 2.3 | 0.5 | 4.6 | 10% | 6% |
| Embodiment 10 | | | | | |
| Embodiment 7 | 2.0 | 0.5 | 5 | 5% | 5% |
| Embodiment 4 | 2.0 | 0.2 | 6 | 20% | 0% |
| Embodiment 8 | 2.0 | 0.2 | 6 | 5% | 7% |
| Embodiment 9 | 0.8 | 0.5 | 8 | 20% | 9% |
| Embodiment 10 | 0.8 | 0.5 | 8 | 5% | 3.5% |
| Embodiment 11 | 0.9 | 0.28 | 12 | 5% | 5% |
| Embodiment 12 | 1.1 | 0.35 | 10 | 15% | 5% |

TABLE 1
(Continued)

| | | | Difference | |
|---|---|---|---|---|
| | Specific | | in Fe content | |
| | surface area | Cracking | between | −20° C. |
| | of lithium | of | upper layer | low- |
| | manganese | electrode | and lower | temperature |
| | oxide | plate | layer | discharge |
| Embodiment | (m²/g) | (mm) | (wt %) | performance |
| Embodiment 1 | 0.5 | No | 0% | 91% |
| Comparative | 0.5 | No | 0% | 91.1% |
| Embodiment 1 | | | | |
| Comparative | 0.5 | 0.25 | 0.3% | 73% |
| Embodiment 2 | | | | |
| Comparative | 0.5 | 0.6 | 0.55% | 65% |
| Embodiment 3 | | | | |
| Embodiment 2 | 0.5 | 0.3 | 0.2% | 83% |
| Embodiment 3 | 0.5 | No | 0% | 89% |
| Comparative | 0.5 | 0.6 | 0.55% | 84% |
| Embodiment 4 | | | | |
| Comparative | 0.5 | No | 0% | 70% |
| Embodiment 5 | | | | |
| Comparative | 0.5 | 0.6 | 0.55% | 81% |
| Embodiment 6 | | | | |
| Comparative | 0.5 | 1.5 | 1.0% | 85% |
| Embodiment 7 | | | | |
| Embodiment 4 | 0.7 | No | 0.3% | 78% |
| Embodiment 5 | 0.7 | No | 0.1% | 75% |
| Comparative | 0.5 | 1.5 | 1.0% | 89% |
| Embodiment 8 | | | | |
| Embodiment 6 | 0.6 | 0.2 | 0% | 87% |
| Comparative | 0.6 | No | 0% | 74% |
| Embodiment 9 | | | | |
| Comparative | 0.65 | No | 0% | 70% |
| Embodiment 10 | | | | |
| Embodiment 7 | 0.65 | No | 0% | 89% |
| Embodiment 4 | 0.7 | No | 0.3% | 78% |
| Embodiment 8 | 0.65 | No | 0% | 86% |
| Embodiment 9 | 0.45 | No | 0.1% | 80% |
| Embodiment 10 | 0.45 | No | 0% | 87% |
| Embodiment 11 | 0.45 | No | 0.1% | 90% |
| Embodiment 12 | 0.55 | No | 0.1% | 90% |

The positive electrode material used in the embodiments and comparative embodiments in Table 1 is a mixture of lithium iron phosphate, lithium nickel cobalt manganese oxide, and lithium manganese oxide. Table 1 shows the mass percent of lithium iron phosphate and lithium nickel cobalt manganese oxide in the positive electrode material, and the rest is lithium manganese oxide.

Referring to Embodiment 1 and Comparative Embodiments 1 to 3, in Embodiment 1, no cracking of the electrode plate occurs, and there is almost no difference in the Fe content between the upper layer and the lower layer, indicating that the lithium iron phosphate is evenly distributed in the positive active material layer without causing cracking of the positive active material layer, and exhibits good low-temperature discharge performance.

In Comparative Embodiment 1, the mass percent of lithium iron phosphate is overly low, resulting in manganese dissolution (although not recorded in the table, manganese dissolution occurs in Comparative Embodiment 1 as tested), and posing safety hazards. By contrast, in Embodiment 1, no manganese dissolution occurs, and the safety performance is high.

In Comparative Embodiments 2 and 3, the mass percent of lithium iron phosphate is overly high, and evidently, makes the low-temperature cycle performance begin to decline. The higher the mass percent of lithium iron phosphate, the lower the low-temperature cycle performance. In addition, the positive active material layer begins to exhibit problems of uneven Fe distribution and cracking. A possible reason is that the mass percent of lithium iron phosphate is overly high, and consequently, the excessive lithium iron phosphate is unable to be sufficiently adsorbed onto the surface of lithium manganese oxide. The excess lithium iron phosphate floats up, resulting in a sharp difference in Fe content between the upper layer and the lower layer and cracking of the electrode plate. The low-temperature performance of the electrochemical device is impaired when the lithium iron phosphate is excessive.

Evidently, the mass percent of lithium iron phosphate, denoted as a, needs to be controlled to fall within the range of 5 wt %≤a≤20 wt %.

Referring to Embodiments 2 to 3 and Comparative Embodiments 4 to 7, in Embodiments 2 to 3, Dᵥ₅₀ is 0.8 μm and 2.0 μm, the electrode plate is free from cracks larger than 0.3 mm, the difference in Fe content between the upper layer and the lower layer is relatively small, and the low-temperature discharge performance is relatively high.

In Comparative Embodiments 4, 6, and 7, Dᵥ₅₀ of the lithium iron phosphate is overly small, thereby resulting in cracking of the electrode plate and uneven distribution of Fe. In Comparative Embodiment 5, Dᵥ₅₀ of the lithium iron phosphate is overly large, thereby resulting in a significant decline in the low-temperature discharge performance.

Evidently, Dᵥ₅₀ of the lithium iron phosphate needs to be controlled to fall within the range of 0.8 μm to 2.0 μm.

Referring to Embodiments 4 to 5 and Comparative Embodiment 8, in Embodiments 4 to 5, Dₙ₁₀ of the lithium iron phosphate is 0.2 μm and 0.5 μm, the electrode plate is free from cracks, the difference in Fe content between the upper layer and the lower layer is relatively small, and the low-temperature discharge performance is relatively high.

In Comparative Embodiment 8, Dₙ₁₀ of the lithium iron phosphate is overly small, resulting in cracks in the electrode plate, and the distribution of Fe is uneven. A possible reason is that the lithium iron phosphate is prone to float in the positive electrode slurry due to a relatively small particle diameter, thereby resulting in uneven distribution of lithium iron phosphate in the positive active material layer, and in turn, giving rise to cracks in the positive active material layer.

Evidently, Dₙ₁₀ of the lithium iron phosphate needs to be controlled to fall within the range of 0.2 μm to 0.5 μm.

Referring to Embodiment 6 and Comparative Embodiments 9 and 10, in Embodiment 6, the specific surface area of lithium iron phosphate is greater than 5 m²/g. By contrast, the specific surface area of lithium iron phosphate in Comparative Embodiments 9 and 10 is less than 5 m²/g. The low-temperature discharge performance of the lithium iron phosphate in Comparative Embodiments 9 and 10 declines significantly. A possible reason is that the lithium iron phosphate does not coat the lithium manganese oxide properly, thereby resulting in manganese dissolution, and reducing the low-temperature performance.

As can be seen, the specific surface area of the lithium iron phosphate needs to be greater than 5 m²/g.

In Embodiment 4 and Embodiments 7 to 12, the mass percent falls within the range of 5 wt %≤ a≤20 wt % specified herein. Dᵥ₅₀ of lithium iron phosphate is 0.8 μm to 2.0 μm, Dₙ₁₀ of lithium iron phosphate is 0.2 μm to 0.5 μm, and the specific surface area of lithium iron phosphate is not less than 5 m²/g. In Embodiment 4 and Embodiments 7 to 12, no cracks occur, the difference in the Fe content between the upper layer and the lower layer in each embodiment is not greater than 0.3%, and the −20° C. low-temperature discharge performance is relatively high. This indicates that, when the parameter values fall within the range specified herein, the lithium iron phosphate does not float up, and therefore, no difference in the distribution of Fe occurs. In addition, the electrode plate does not crack, and good low-temperature performance is ensured.

It can also be seen from Embodiment 4 and Embodiments 7 to 12 that the difference in the Fe content between the upper layer and the lower layer is the largest in Embodiment 4. A possible reason is that, in Embodiment 4, the particle diameter of the lithium iron phosphate is relatively small, the mass percent of the lithium iron phosphate is relatively high, and the specific surface area is relatively large. In this case, the lithium iron phosphate characterized by a small particle diameter is prone to float. Therefore, it can be seen that the mass percent of lithium iron phosphate, the particle diameter, and the specific surface area jointly affect the performance of the positive electrode. The overall performance is superior only when all the characteristic ranges specified herein are satisfied.

In Embodiment 4, the mass percent of lithium nickel cobalt manganese oxide is 0. As can be seen, when the positive electrode material contains only lithium iron phosphate and lithium manganese oxide, it is ensured that the quality of the electrode plate is high, the distribution of Fe is uniform, and the low-temperature performance is high as long as the following conditions are met: the mass percent falls within the range of 5 wt %≤a≤20 wt % specified herein, Dᵥ₅₀ of lithium iron phosphate is 0.8 μm to 2.0 μm, Dₙ₁₀ of lithium iron phosphate is 0.2 μm to 0.5 μm, and the specific surface area of lithium iron phosphate is not less than 5 m²/g.

In Embodiment 12, the mass percent of lithium nickel cobalt manganese oxide is 5%, the capacity retention rate of the lithium-ion battery discharged at low temperature reaches 90%, and the low-temperature discharge performance is excellent. That is because the mass percent falls with the range of 10 wt %≤a≤20 wt %, Dᵥ₅₀ of lithium iron phosphate is 1.1 μm to 1.8 μm, Dₙ₁₀ of lithium iron phosphate is 0.2 μm to 0.4 μm, and the specific surface area of lithium iron phosphate is greater than 8 m²/g. In this case, the parameters of lithium iron phosphate are optimal, and therefore, the lithium iron phosphate exhibits the optimal low-temperature performance, and the Fe element is distributed evenly.

The above descriptions are merely exemplary embodiments of this application and the technical principles thereof. A person skilled in the art understands that the invention scope covered by the embodiments of this application is not limited to the technical solutions formed from specified combinations of the foregoing technical features, but covers other technical solutions formed by combining the foregoing technical features or equivalents thereof in any manner without departing from the conceptions disclosed herein. For example, the invention scope hereof also covers the technical solutions formed by replacing any of the foregoing features with (but not limited to) the technical features serving similar functions disclosed herein.

What is claimed is:

1. An electrochemical device, comprising:
a positive electrode, wherein the positive electrode comprises a positive current collector and a positive active material layer located on one surface or both surfaces of the positive current collector, the positive active material layer comprises a positive electrode material, and the positive electrode material comprises lithium manganese oxide and lithium iron phosphate; and
based on a total mass of the positive electrode material, a mass percent of the lithium iron phosphate is denoted as a, 5 wt %≤a≤20 wt %; Dᵥ₅₀ of the lithium iron phosphate is 0.8 μm to 2.0 μm; Dₙ₁₀ of the lithium iron phosphate is 0.2 μm to 0.5 μm; and a specific surface area of the lithium iron phosphate is not less than 5 m²/g.

2. The electrochemical device according to claim 1, wherein the electrochemical device satisfies at least one of the following conditions:
(a) 10 wt %≤a≤20 wt %;
(b) Dᵥ₅₀ of the lithium iron phosphate is 1.1 μm to 1.8 μm;
(c) Dₙ₁₀ of the lithium iron phosphate is 0.2 μm to 0.4 μm;
(d) the specific surface area of the lithium iron phosphate is greater than 8 m²/g.

3. The electrochemical device according to claim 1, wherein,
a specific surface area of the lithium manganese oxide is 0.2 m²/g to 0.7 m²/g.

4. The electrochemical device according to claim 1, wherein,
the positive electrode material further comprises lithium nickel cobalt manganese oxide;
based on the total mass of the positive electrode material, a mass percent of the nickel cobalt manganese oxide is denoted as b, 0 wt %<b≤10 wt %.

5. The electrochemical device according to claim 4, wherein at least a part of the positive electrode material is a core-shell structure, the lithium manganese oxide is located in a core of the core-shell structure, and the lithium iron phosphate and the lithium nickel cobalt manganese oxide are located in a shell layer of the core-shell structure.

6. The electrochemical device according to claim 1, wherein at least a part of the positive electrode material is a core-shell structure, the lithium manganese oxide is located in a core of the core-shell structure, and the lithium iron phosphate is located in a shell layer of the core-shell structure.

7. The electrochemical device according to claim 1, wherein the positive electrode material comprises at least one of B, Mg, Al, Si, S, Ti, Cr, Cu, Zn, Ga, Ge, Y, Zr, Mo, Ag, Ba, W, In, Sn, Pb, or Sb.

8. The electrochemical device according to claim 1, wherein the positive active material layer comprises a first layer and a second layer; the first layer is located between the positive current collector and the second layer; and a difference between a mass percent of iron element in the first layer and a mass percent of iron element in the second layer is not greater than 0.5%.

9. The electrochemical device according to claim 8, wherein a difference between a thickness of the first layer and a thickness of the second layer is not greater than 20%.

10. The electrochemical device according to claim 8, wherein
the first layer comprises lithium manganese oxide and lithium iron phosphate, and the second layer comprises lithium manganese oxide and lithium iron phosphate; or
the first layer comprises lithium manganese oxide, lithium iron phosphate, or lithium nickel cobalt manganese oxide, and the second layer comprises lithium manganese oxide, lithium iron phosphate, and lithium nickel cobalt manganese oxide.

11. The electrochemical device according to claim 8, wherein
based on the total mass of the positive electrode material, a mass percent of the lithium manganese oxide in the second layer is d; and
based on the total mass of the positive electrode material, a mass percent of the lithium manganese oxide in the first layer is e, and d<e.

12. An electronic device, comprising an electrochemical device, the electrochemical device comprising:
a positive electrode, wherein the positive electrode comprises a positive current collector and a positive active material layer located on one surface or both surfaces of the positive current collector, the positive active material layer comprises a positive electrode material, and the positive electrode material comprises lithium manganese oxide and lithium iron phosphate; and
based on a total mass of the positive electrode material, a mass percent of the lithium iron phosphate is denoted as a, 5 wt %≤a≤20 wt %; Dᵥ₅₀ of the lithium iron phosphate is 0.8 μm to 2.0 μm; Dₙ₁₀ of the lithium iron phosphate is 0.2 μm to 0.5 μm; and a specific surface area of the lithium iron phosphate is not less than 5 m²/g.

13. The electronic device according to claim 12, wherein the electrochemical device satisfies at least one of the following conditions:
(a) 10 wt %≤a≤20 wt %;
(b) Dᵥ₅₀ of the lithium iron phosphate is 1.1 μm to 1.8 μm;
(c) Dₙ₁₀ of the lithium iron phosphate is 0.2 μm to 0.4 μm;
(d) the specific surface area of the lithium iron phosphate is greater than 8 m²/g.

14. The electronic device according to claim 12, wherein,
a specific surface area of the lithium manganese oxide is 0.2 m²/g to 0.7 m²/g; or, the positive electrode material further comprises lithium nickel cobalt manganese oxide, based on the total mass of the positive electrode material, a mass percent of the nickel cobalt manganese oxide is denoted as b, 0 wt %<b≤10 wt %.

15. The electronic device according to claim 14, wherein at least a part of the positive electrode material is a core-shell structure, the lithium manganese oxide is located in a core of the core-shell structure, and the lithium iron phosphate and the lithium nickel cobalt manganese oxide are located in a shell layer of the core-shell structure.

16. The electronic device according to claim 12, wherein at least a part of the positive electrode material is a core-shell structure, the lithium manganese oxide is located in a core of the core-shell structure, and the lithium iron phosphate is located in a shell layer of the core-shell structure; or,
the positive electrode material comprises at least one of B, Mg, Al, Si, S, Ti, Cr, Cu, Zn, Ga, Ge, Y, Zr, Mo, Ag, Ba, W, In, Sn, Pb, or Sb.

17. The electronic device according to claim 12, wherein the positive active material layer comprises a first layer and a second layer; the first layer is located between the positive current collector and the second layer; and a difference between a mass percent of iron element in the first layer and a mass percent of iron element in the second layer is not greater than 0.5%.

18. The electronic device according to claim 17, wherein a difference between a thickness of the first layer and a thickness of the second layer is not greater than 20%.

19. The electronic device according to claim 17, wherein
the first layer comprises lithium manganese oxide and lithium iron phosphate, and the second layer comprises lithium manganese oxide and lithium iron phosphate; or
the first layer comprises lithium manganese oxide, lithium iron phosphate, or lithium nickel cobalt manganese oxide, and the second layer comprises lithium manganese oxide, lithium iron phosphate, and lithium nickel cobalt manganese oxide.

20. The electronic device according to claim 17, wherein
based on the total mass of the positive electrode material, a mass percent of the lithium manganese oxide in the second layer is d; and
based on the total mass of the positive electrode material, a mass percent of the lithium manganese oxide in the first layer is e, and d<e.
